(19) United States
(12) Patent Application Publication
(10) Pub. No.: US 2020/0387540 A1
(43) Pub. Date: Dec. 10, 2020

(54) SYSTEMS AND METHODS FOR AUTOMATIC GENERATION OF BOOKMARKS UTILIZING FOCUSED CONTENT ANALYSIS

(71) Applicant: CyberLink Corp., Shindian City (TW)

(72) Inventor: Hung-En CHEN, New Taipei City (TW)

(21) Appl. No.: 16/892,361

(22) Filed: Jun. 4, 2020

Related U.S. Application Data
(60) Provisional application No. 62/856,878, filed on Jun. 4, 2019.

(51) Int. Cl. G06F 16/732; G06F 16/74; G06F 16/783

(52) U.S. Cl. CPC G06F 16/7335; G06F 16/7837; G06F 16/748

(57) ABSTRACT

A computing device initiates a video desktop recording capturing activities on a desktop displayed on the computing device, wherein during the video desktop recording, the computing device is further configured to detect at least one window within the video desktop recording, and identify a target window from among the at least one window detected within the video desktop recording. The computing device is further configured to generate a bookmark comprising metadata associated with the target window responsive to identifying the target window, the metadata comprising a time stamp when the target window was identified. The computing device is further configured to store the bookmark as part of the video desktop recording.

### CROSS-REFERENCE TO RELATED APPLICATION

This application claims priority to, and the benefit of, U.S. Provisional Patent Application entitled, “Method of Bookmarking in Desktop Recording by Focused Content Analysis,” having Ser. No. 62/856,878, filed on Jun. 4, 2019, which is incorporated by reference in its entirety.

### TECHNICAL FIELD

The present disclosure generally relates to systems and methods for automatically generating bookmarks for desktop video recordings utilizing focused content analysis.

### BACKGROUND

Desktop video recordings can be useful for a wide range of applications by allowing others to view all the mouse movements, clicks, and so on while an individual navigates between one or more desktop windows. Furthermore, such desktop video recordings can be accompanied by audio to further guide the viewer. However, it can be a tedious process to search for specific segments within a lengthy desktop video recording to identify segments of interest.

### SUMMARY

In accordance with one embodiment, a computing device initiates a video desktop recording capturing activities on a desktop displayed on the computing device, wherein during the video desktop recording, the computing device is further configured to detect at least one window within the video desktop recording, and identify a target window from among the at least one window detected within the video desktop recording. The computing device is further configured to generate a bookmark comprising metadata associated with the target window responsive to identifying the target window, the metadata comprising a time stamp when the target window was identified. The computing device is further configured to store the bookmark as part of the video desktop recording.

Another embodiment is a system that comprises a memory storing instructions and a processor coupled to the memory. The processor is configured by the instructions to initiate a video desktop recording capturing activities on a desktop displayed on the computing device, wherein during the video desktop recording, the processor is further configured to detect at least one window within the video desktop recording, and identify a target window from among the at least one window detected within the video desktop recording. The processor is further configured to generate a bookmark comprising metadata associated with the target window responsive to identifying the target window, the metadata comprising a time stamp when the target window was identified. The processor is further configured to store the bookmark as part of the video desktop recording.

Another embodiment is a non-transitory computer-readable storage medium storing instructions to be implemented by a computing device having a front-facing camera and a processor, wherein the instructions, when executed by the processor, cause the computing device to initiate a video desktop recording capturing activities on a desktop displayed on the computing device, wherein during the video desktop recording, the processor is further configured to detect at least one window within the video desktop recording, and identify a target window from among the at least one window detected within the video desktop recording. The processor is further configured to generate a bookmark comprising metadata associated with the target window responsive to identifying the target window, the metadata comprising a time stamp when the target window was identified. The processor is further configured to store the bookmark as part of the video desktop recording.

In accordance with another embodiment, a computing device initiates a video desktop recording capturing activities on a desktop displayed on the computing device, wherein during the video desktop recording, the computing device is further configured to detect a change in content displayed in a window detected within the video desktop recording and generate a bookmark comprising metadata associated with the window responsive to detecting the change in the content displayed in the window, the metadata comprising a time stamp when the change in the content was detected. The computing device is further configured to store the bookmark as part of the video desktop recording.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Various aspects of the disclosure can be better understood with reference to the following drawings. The components in the drawings are not necessarily to scale, with emphasis instead being placed upon clearly illustrating the principles of the present disclosure. Moreover, in the drawings, like reference numerals designate corresponding parts throughout the several views.

FIG. 1 is a block diagram of a computing device for generating bookmarks for a desktop video recording utilizing focused content analysis in accordance with various embodiments of the present disclosure.

FIG. 2 is a schematic diagram of the computing device of FIG. 1 in accordance with various embodiments of the present disclosure.

FIG. 3 is a top-level flowchart illustrating examples of functionality implemented as portions of the computing device of FIG. 1 for generating bookmarks for a desktop video recording utilizing focused content analysis according to various embodiments of the present disclosure.

FIGS. 4A to 4C illustrate how different target windows are identified and corresponding bookmarks are generated by the computing device of FIG. 1 according to various embodiments of the present disclosure.

FIG. 5 illustrates examples of bookmarks generated based on the user's actions depicted in FIGS. 4A to 4C according to various embodiments of the present disclosure.

FIG. 6 illustrates an example where the computing device of FIG. 1 determines a target window among a plurality of windows according to various embodiments of the present disclosure.

FIG. 7 illustrates an example where the computing device in FIG. 1 automatically designates a window is a maximized state as a target window according to various embodiments of the present disclosure.

### DETAILED DESCRIPTION

Desktop video recordings can be useful for a wide range of applications by allowing others to view all the mouse movements, clicks, and so on while an individual navigates between one or more desktop windows. This may be useful, for example, if an individual wishes to show viewers various video editing techniques. However, it can be a tedious process to search for specific segments within a lengthy desktop video recording to identify segments of interest.

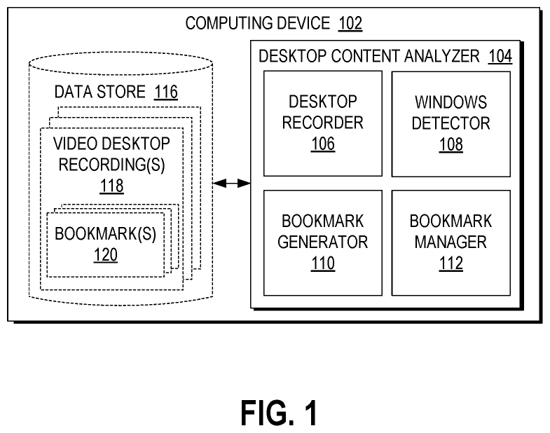

A description of a system for automatically generating bookmarks for a desktop video recording utilizing focused content analysis is now described followed by a discussion of the operation of the components within the system. FIG. 1 is a block diagram of a computing device 102 in which techniques disclosed herein may be implemented. The computing device 102 may be embodied as a computing device such as, but not limited to, a smartphone, a tablet computing device, a laptop, and so on.

A desktop content analyzer 104 executes on a processor of the computing device 102 and includes a desktop recorder 106, a windows detector 108, a bookmark generator 110, and a bookmark manager 112. The desktop recorder 106 is configured to initiate a video desktop recording that captures activities on a desktop displayed on the computing device 102 and store the video desktop recordings 118 in a data store 116.

As one of ordinary skill will appreciate, the video desktop recording 118 may be encoded in formats including, but not limited to, Motion Picture Experts Group (MPEG)-1, MPEG-2, MPEG-4, H.264, Third Generation Partnership Project (3GPP), 3GPP-2, Standard-Definition Video (SD-Video), High-Definition Video (HD-Video), Digital Versatile Disc (DVD) multimedia, Video Compact Disc (VCD) multimedia, High-Definition Digital Versatile Disc (HD-DVD) multimedia, Digital Television Video/High-definition Digital Television (DTV/HDTV) multimedia, Audio Video Interleave (AVI), Digital Video (DV), QuickTime (QT) file, Windows Media Video (WMV), Advanced System Format (ASF), Real Media (RM), Flash Media (FLV), an MPEG Audio Layer III (MP3), an MPEG Audio Layer II (MP2), Waveform Audio Format (WAV), Windows Media Audio (WMA), or any number of other digital formats.

For some embodiments, the functions described below for the windows detector 108, the bookmark generator 110, and the bookmark manager 112 are respectively performed on the fly while activities on the desktop are being recorded (i.e., while a video desktop recording 118 is being captured). However, for alternative embodiments, the functions described below for the windows detector 108, the bookmark generator 110, and the bookmark manager 112 are respectively performed after the video desktop recording 118 has been captured. For such embodiments, post-processing is applied and the functions described below are performed during playback of the video desktop recording 118.

The windows detector 108 is configured to detect the presence of one or more windows depicted within the video desktop recording 118. The windows detector 108 is further configured to identify a target window from among one or more windows detected within the video desktop recording 118. For some embodiments, the windows detector 108 identifies the target window among one or more windows by determining whether at least one or more of the windows detected within the video desktop recording is in a restored state. If one or more of the windows is in the restored state, the windows detector 108 determines a top-most window among the windows in the desktop and designates the top-most window as the target window.

For some embodiments, the windows detector 108 determines the top-most window by submitting a query to the operating system executing on the computing device 102, where the query requests enumeration of windows present on the desktop displayed on the computing device 102. In response to the query, some operating systems will return information relating to each of the windows sorted according to a z-order, starting with the top-most window to the bottom-most window. For some embodiments, the windows detector 108 begins by designating the top-most window as a candidate target window and then enumerating each of the windows one by one starting from top-most window and then determining whether the candidate target window qualifies as an actual target window.

In general, the top-most window will be designated as the target window. However, in some instances, certain top-most windows will not be designated as the target window. For example, invoking the start menu in an operating system will typically cause a top-most window to appear whereby the user can select an application from the start menu. As it is unlikely that the window associated with the start menu will be a window of interest in the desktop presentation, such windows can be filtered so that these window types will not be designated as the target window. Another example is a toolbar window that is invoked by the user using, for example, a right mouse click. Again, it is unlikely that the toolbar window will be a window of interest in the desktop presentation. Therefore, this window is similarly filtered so that this window is not designated as the target window. Such window types that do not qualify as target windows can be predefined and filter rules may be implemented by the windows detector 108.

The windows detector 108 then designates the window associated with a first window among the enumerated windows as the target window. In particular, the order in which the operating system returns information relating to each of the windows on the desktop represents the z-order of the windows. The first window among the enumerated windows corresponds to the top-most window and is therefore designated as the target window. For some embodiments, if one of the windows is in a maximized state, the windows detector 108 automatically designates that window as the target window. For example, if the user is using a presentation application (e.g., PowerPoint®) and one of the windows is in a maximized state, the windows detector 108 may automatically designate that window as the target window.

Every time a target window is identified, the bookmark generator 110 is configured to generate a bookmark 120 comprising metadata associated with the target window, the metadata comprising a time stamp when the target window was identified. That is, as the user shifts focus to a different window within the desktop, a new target window is identified, thereby causing a new bookmark 120 to be automatically generated. For example, if the user minimizes a first window and clicks on a second window, the second window is designated as a new target window, and the bookmark generator 110 automatically generates a bookmark 120 for the second window.

For some embodiments, a target window is determined based on the content shown in windows, where a change in content shown in a window will cause a new target window to be identified and a new bookmark 120 to be generated. For example, a title change of a particular window or a change in the page number in a document shown in a particular window will cause a new bookmark 120 to be generated for that particular window. Other examples of content change include loading of an image in a window, modification of an image in an image editor in a window, playback of a video in a window, and so on. Any of these events will case a target window to be identified and a corresponding bookmark 120 to be generated. Note that a new bookmark 120 will be generated even if the current window is already designated as a target window. In particular, a change in the content of a current target window will cause that same window to be designated as a new target window due to the change in content, and a new bookmark 120 is generated accordingly.

For some embodiments, a target window is determined based on the opening or closing of windows. For example, opening a new Internet browser window will result in that window being designated as a target window, and a new bookmark 120 is generated accordingly. As another example, closing a window and causing a second window to be the topmost window will result in the second window being designated as a target window, and a new bookmark 120 is generated accordingly.

For some embodiments, the metadata further comprises a title of the target window, a process identifier associated with the target window assigned by an operating system executing on the computing device, and a descriptor relating to content within the target window. For some embodiments, the metadata may also include a graphical representation of the target window. The bookmark manager 112 is configured to store the bookmark 120 as part of the video desktop recording 118 and store the video desktop recording 118 back in the data store 116.

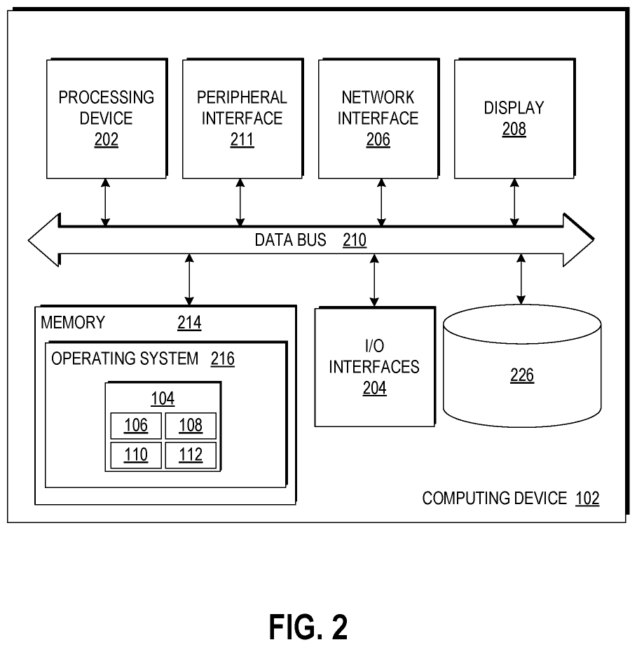

FIG. 2 illustrates a schematic block diagram of the computing device 102 in FIG. 1. The computing device 102 may be embodied in any one of a wide variety of wired and/or wireless computing devices, such as a desktop computer, portable computer, dedicated server computer, multiprocessor computing device, smart phone, tablet, and so forth. As shown in FIG. 2, the computing device 102 comprises memory 214, a processing device 202, a number of input/output interfaces 204, a network interface 206, a display 208, a peripheral interface 211, and mass storage 226, wherein each of these components are connected across a local data bus 210.

The processing device 202 may include any custom made or commercially available processor, a central processing unit (CPU) or an auxiliary processor among several processors associated with the computing device 102, a semiconductor based microprocessor (in the form of a microchip), a macroprocessor, one or more application specific integrated circuits (ASICs), a plurality of suitably configured digital logic gates, and other well known electrical configurations comprising discrete elements both individually and in various combinations to coordinate the overall operation of the computing system.

The memory 214 may include any one of a combination of volatile memory elements (e.g., random-access memory (RAM, such as DRAM, and SRAM, etc.)) and nonvolatile memory elements (e.g., ROM, hard drive, tape, CDROM, etc.). The memory 214 typically comprises a native operating system 216, one or more native applications, emulation systems, or emulated applications for any of a variety of operating systems and/or emulated hardware platforms, emulated operating systems, etc. For example, the applications may include application specific software which may comprise some or all the components of the computing device 102 depicted in FIG. 1. In accordance with such embodiments, the components are stored in memory 214 and executed by the processing device 202, thereby causing the processing device 202 to perform the operations/functions disclosed herein. One of ordinary skill in the art will appreciate that the memory 214 can, and typically will, comprise other components which have been omitted for purposes of brevity. For some embodiments, the components in the computing device 102 may be implemented by hardware and/or software.

Input/output interfaces 204 provide any number of interfaces for the input and output of data. For example, where the computing device 102 comprises a personal computer, these components may interface with one or more user input/output interfaces 204, which may comprise a keyboard or a mouse, as shown in FIG. 2. The display 208 may comprise a computer monitor, a plasma screen for a PC, a liquid crystal display (LCD) on a hand held device, a touchscreen, or other display device.

In the context of this disclosure, a non-transitory computer-readable medium stores programs for use by or in connection with an instruction execution system, apparatus, or device. More specific examples of a computer-readable medium may include by way of example and without limitation: a portable computer diskette, a random access memory (RAM), a read-only memory (ROM), an erasable programmable read-only memory (EPROM, EEPROM, or Flash memory), and a portable compact disc read-only memory (CDROM) (optical).

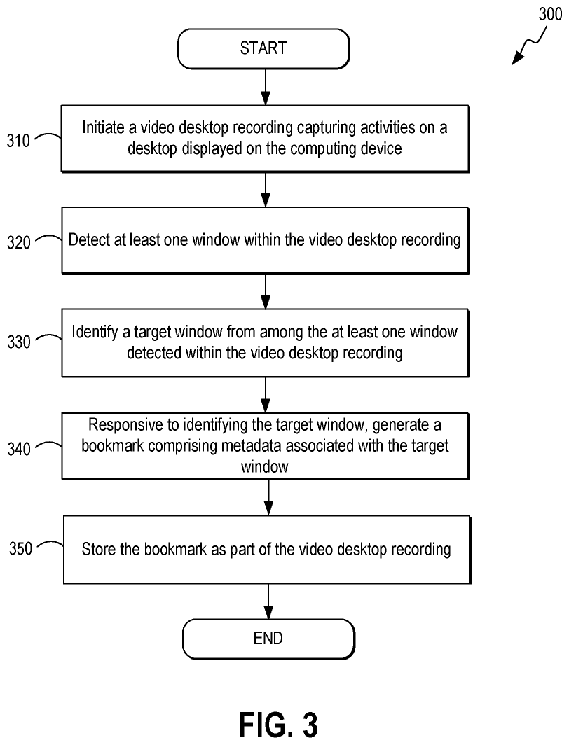

Reference is made to FIG. 3, which is a flowchart 300 in accordance with various embodiments for generation of bookmarks for desktop video recordings utilizing focused content analysis performed by the computing device 102 of FIG. 1. It is understood that the flowchart 300 of FIG. 3 provides merely an example of the different types of functional arrangements that may be employed to implement the operation of the various components of the computing device 102. As an alternative, the flowchart 300 of FIG. 3 may be viewed as depicting an example of steps of a method implemented in the computing device 102 according to one or more embodiments.

Although the flowchart 300 of FIG. 3 shows a specific order of execution, it is understood that the order of execution may differ from that which is depicted. For example, the order of execution of two or more blocks may be scrambled relative to the order shown. Also, two or more blocks shown in succession in FIG. 3 may be executed concurrently or with partial concurrence. It is understood that all such variations are within the scope of the present disclosure.

At block 310, the computing device 102 (FIG. 1) initiates a video desktop recording capturing activities on a desktop displayed on the computing device 102 and stores the video desktop recordings 118 (FIG. 1) in a data store 116 (FIG. 1). At block 320, the computing device 102 detects the presence of one or more windows depicted within the video desktop recording 118.

At block 330, the computing device 102 identifies a target window from among the one or more windows detected within the video desktop recording 118. For some embodiments, the computing device 102 identifies the target window among one or more windows by determining whether at least one window detected within the video desktop recording is in a restored state. In accordance with various embodiments, a window in a restored state refers to a window that is not in a maximized state. If at least one of the windows is in the restored state, the computing device 102 determines a top-most window among the windows in the desktop and designates the top-most window as the target window. For some embodiments, the computing device 102 determines the top-most window by submitting a query to the operating system executing on the computing device 102, where the query requests enumeration of windows present on the desktop displayed on the computing device 102.

The computing device 102 then designates the window associated with a first window among the enumerated windows as the target window since the order in which the operating system returns information relating to each of the windows on the desktop represents the z-order of the windows. Thus, the first window among the enumerated windows corresponds to the top-most window and is therefore designated as the target window. For some embodiments, if one of the windows is in a maximized state, the computing device 102 designates that window as the target window.

For some embodiments, the computing device 102 identifies the target window from among the one or more windows detected within the video desktop recording by detecting a change in content displayed in one of the at least one window detected within the video desktop recording and designating a window with the change in content as the target window. For some embodiments, the computing device 102 identifies the target window from among the one or more windows detected within the video desktop recording based on closing a window among the at least one window detected within the video desktop recording and/or opening a new window.

At block 340, in response to identifying the target window, the computing device 102 generates a bookmark 120 (FIG. 1) comprising metadata associated with the target window, the metadata comprising a time stamp when the target window was identified. For some embodiments, the metadata further comprises a title of the target window, a process identifier associated with the target window assigned by an operating system executing on the computing device, a descriptor relating to content within the target window, and so on. For some embodiments, the metadata may also include a graphical representation of the target window.

The computing device 102 is configured to generate a bookmark 120 every time a new target window is identified. For example, if the user minimizes a first window and a second window is identified as a new target window, the computing device 102 is configured to automatically generate a bookmark 120 for the second window. The computing device 102 is configured to store the bookmark 120 as part of the video desktop recording 118 and store the updated video desktop recording 118 back in the data store 116.

For some embodiments, the operations described above in blocks 320 to 350 are performed on the fly while activities on the desktop are being recorded. However, for alternative embodiments, the functions described above in blocks 320 to 350 are performed after the video desktop recording 118 has been captured. For such embodiments, the functions described above in blocks 320 to 350 are performed during playback of the video desktop recording 118. Thereafter, the process in FIG. 3 ends.

In accordance with an alternative embodiment, the computing device 102 (FIG. 1) initiates a video desktop recording capturing activities on a desktop displayed on the computing device 102, wherein during the video desktop recording, the computing device 102 is further configured to detect a change in content displayed in a window detected within the video desktop recording and generate a bookmark comprising metadata associated with the window responsive to detecting the change in the content displayed in the window, the metadata comprising a time stamp when the change in the content was detected. The computing device 102 is further configured to store the bookmark as part of the video desktop recording.

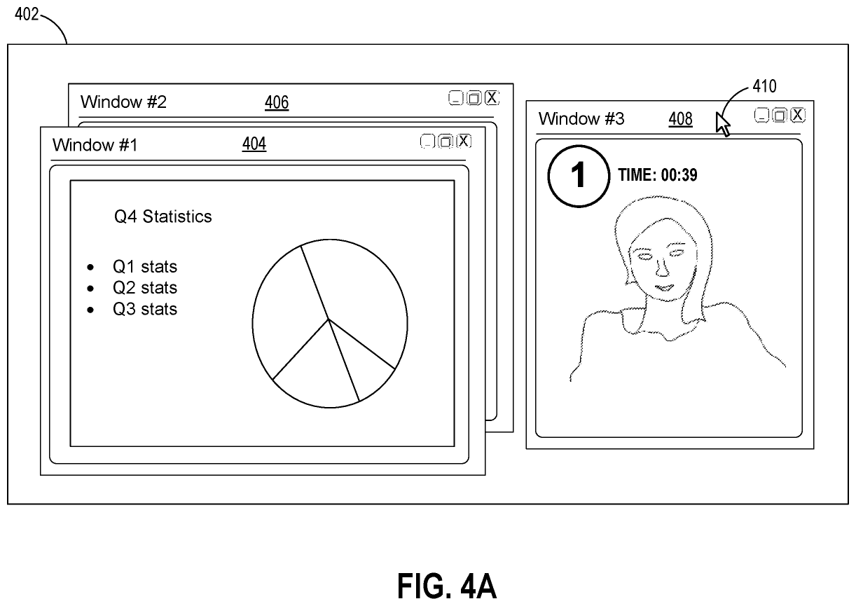

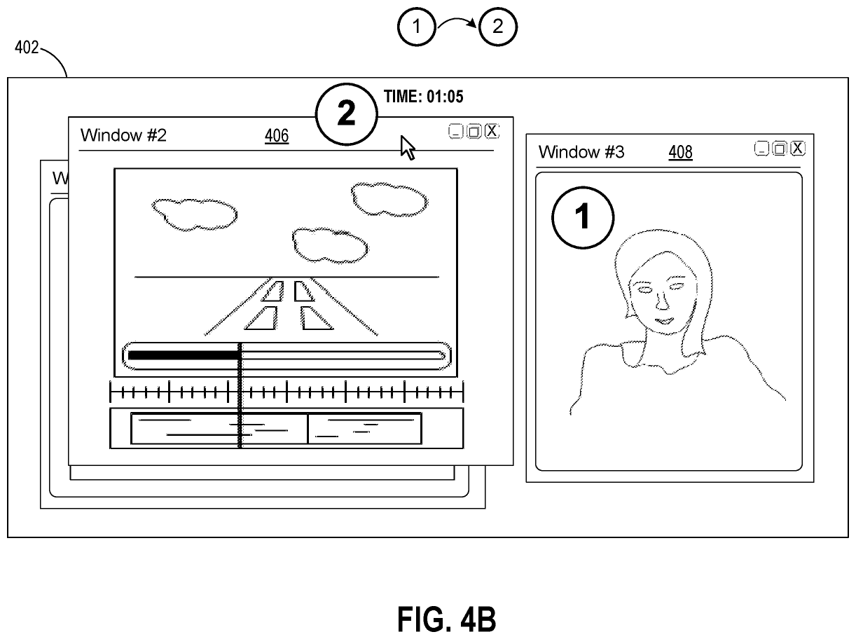

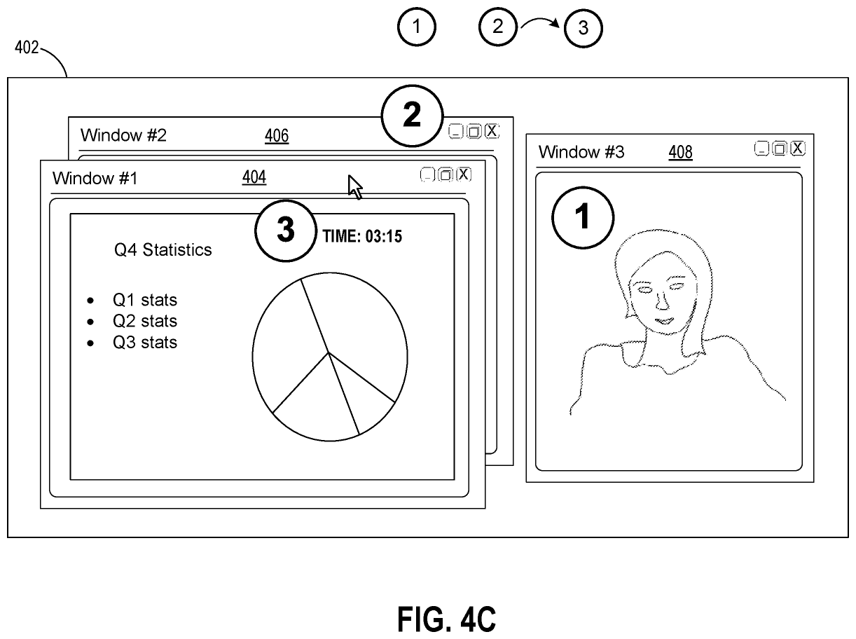

Reference is made to FIGS. 4A to 4C, which illustrate how different target windows are identified and corresponding bookmarks are generated by the computing device 102 of FIG. 1 in accordance with various embodiments. In FIG. 4A, a desktop 402 is shown with multiples windows 404, 406, 408. As discussed above, the computing device 102 detects the presence of one or more windows depicted within a video desktop recording 118 capturing activities on a desktop and identifies a target window from among one or more windows detected within the video desktop recording 118.

For some embodiments, the computing device 102 identifies the target window among the one or more windows by determining whether each of the windows detected within the video desktop recording is in a restored state. In the example shown, each of the windows 404, 406, 408 in the desktop 402 is in a restored state.

In the example shown in FIG. 4A, the window 408 labeled “Window #3” is the top-most window or active window due to selection by the user using a pointer 410. That is, the window 408 labeled “Window #3” is the currently focused window among all the windows 404, 406, 408 and is designated as a target window. As a result, the computing device 102 generates a bookmark 120 (FIG. 1) comprising metadata associated with the target window 408, where the metadata comprises a time stamp (00:39) when the target window 408 was identified. For some embodiments, the metadata further comprises a title of the target window, a process identifier associated with the target window assigned by an operating system executing on the computing device, and a descriptor relating to content within the target window. For some embodiments, the metadata may also include a graphical representation of the target window.

In accordance with exemplary embodiments, the computing device 102 is configured to generate a bookmark 120 every time a new target window is identified. For example, as shown in FIG. 4B, the user selects a new active window (i.e., the window 406 labeled “Window #2”), thereby causing a new target window 406 to be designated. Since a new target window 406 has been identified, the computing device 102 generates a new bookmark 120 comprising metadata associated with the target window 406, where the metadata comprises a time stamp (01:05) when the target window was identified. Similarly, as shown in FIG. 4C, the user selects yet another new active window (i.e., the window 404 labeled “Window #1”), thereby causing a new target window 404 to be designated. Again, this causes the computing device 102 to generate a bookmark 120 comprising metadata associated with the target window 404, where the metadata comprises a time stamp (03:15) when the target window was identified.

As discussed above, the functions described above may be performed on the fly while activities on the desktop are being recorded. However, for alternative embodiments, post-processing of the video desktop recording 118 is applied where the functions described above are performed after the video desktop recording 118 has been captured. For such embodiments, the functions described above are performed during playback of the video desktop recording 118.

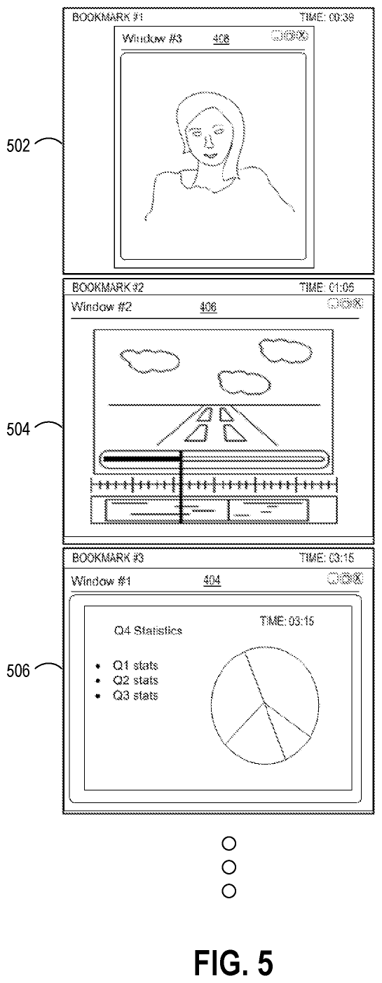

FIG. 5 illustrates examples of bookmarks generated based on the user's actions depicted in FIGS. 4A to 4C in accordance with various embodiments. Examples of bookmarks 502, 504, 506 are shown, where the bookmarks 502, 504, 506 include respective time stamps when each window 404, 406, 408 (FIG. 4) was designated as a target window. The bookmarks 502, 504, 506 also include graphical representations of the corresponding windows 404, 406, 408. During playback of the video desktop recording, the user may utilize the bookmarks to directly view segments of interest.

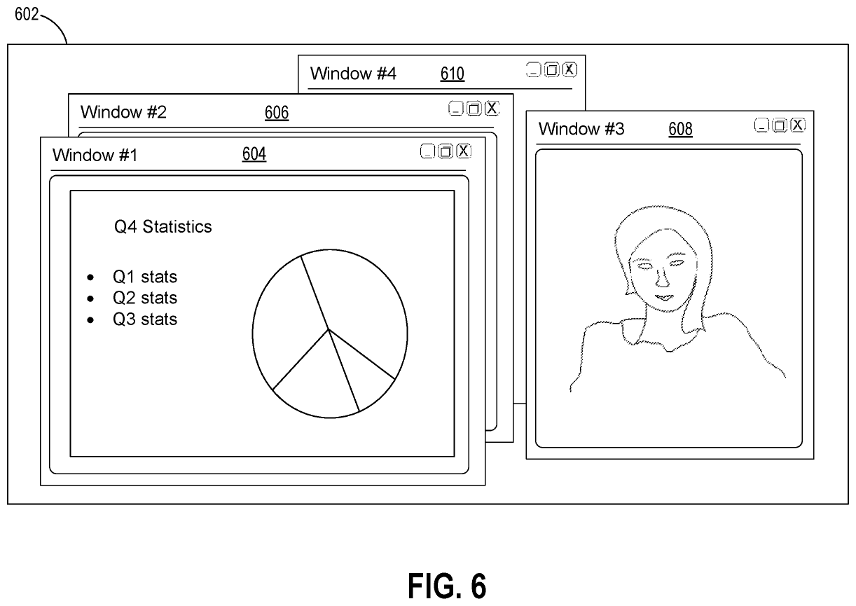

FIG. 6 illustrates an example where the computing device 102 of FIG. 1 determines a target window among a plurality of windows 604, 606, 608, 610. A desktop 602 is shown that includes multiple windows 604, 606, 608, 610. For some embodiments, the computing device 102 determines the top-most window by submitting a query to the operating system executing on the computing device 102, where the query requests enumeration of windows present on the desktop displayed on the computing device 102.

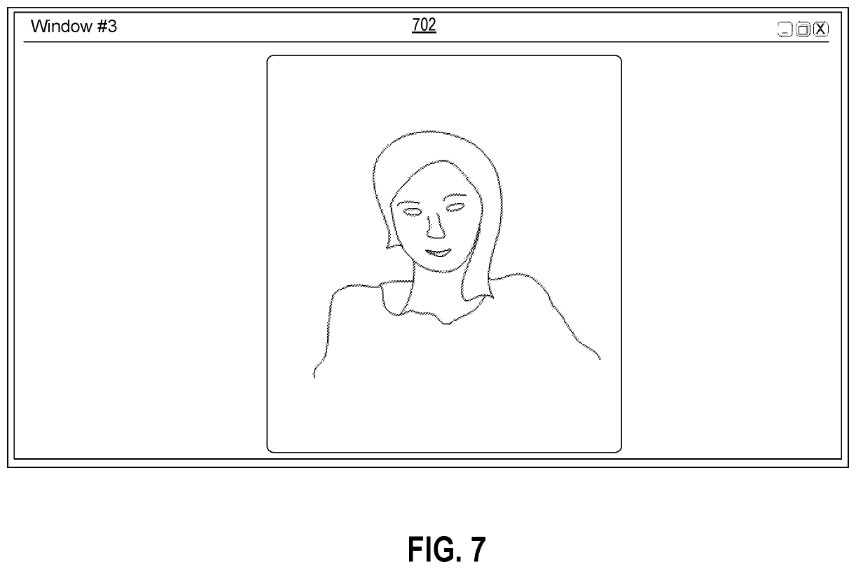

The computing device 102 then designates the window associated with a first window among the enumerated windows as the target window since the order in which the operating system returns information relating to each of the windows on the desktop represents the z-order of the windows. FIG. 7 illustrates an example of a window 702 in a maximized state. In the example shown, since the window 702 is in a maximized state, the computing device 102 (FIG. 1) automatically designates this window 702 as a target window.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

At least the following is claimed:

1. A method implemented in a computing device, comprising:
initiating a video desktop recording capturing activities on a desktop displayed on the computing device, wherein during the video desktop recording, performing the steps of:
detecting at least one window within the video desktop recording;
identifying a target window from among the at least one window detected within the video desktop recording;
responsive to identifying the target window, generating a bookmark comprising metadata associated with the target window, the metadata comprising a time stamp when the target window was identified; and
storing the bookmark as part of the video desktop recording.

2. The method of claim 1, wherein the metadata further comprises: a title of the target window; a process identifier associated with the target window assigned by an operating system executing on the computing device, and a descriptor relating to content within the target window.

3. The method of claim 1, wherein the metadata further comprises a graphical representation of the target window.

4. The method of claim 1, wherein a new bookmark is generated responsive to a new target window being detected.

5. The method of claim 1, wherein identifying the target window from among the at least one window detected within the video desktop recording comprises:
determining whether at least one window detected within the video desktop recording is in a restored state;
responsive to at least one window being in the restored state, performing the steps of:
determining a top-most window among the at least one window; and
designating the top-most window as the target window.

6. The method of claim 5, wherein determining the top-most window among the at least one window, comprises:
submitting a query to an operating system executing on the computing device, the query requesting enumeration of windows present on the desktop displayed on the computing device; and
designating a window associated with a first window among the enumerated windows as the target window.

7. The method of claim 1, wherein identifying the target window from among the at least one window detected within the video desktop recording comprises:
detecting a change in content displayed in one of the at least one window detected within the video desktop recording; and
designating a window with the change in content as the target window.

8. The method of claim 1, wherein identifying the target window from among the at least one window detected within the video desktop recording is performed based on at least one of: closing a window among the at least one window detected within the video desktop recording; or opening a new window.

9. A method implemented in a computing device, comprising:
initiating a video desktop recording capturing activities on a desktop displayed on the computing device, wherein during the video desktop recording, performing the steps of:
detecting a change in content displayed in a window detected within the video desktop recording;
responsive to detecting the change in the content displayed in the window, generating a bookmark comprising metadata associated with the window, the metadata comprising a time stamp when the change in the content was detected; and
storing the bookmark as part of the video desktop recording.

10. A system, comprising:
a memory storing instructions;
a processor coupled to the memory and configured by the instructions to at least:
initiate a video desktop recording capturing activities on a desktop, wherein during the video desktop recording, the processor is further configured to:
detect at least one window within the video desktop recording;
identify a target window from among the at least one window detected within the video desktop recording;
responsive to identifying the target window, generate a bookmark comprising metadata associated with the target window, the metadata comprising a time stamp when the target window was identified; and
store the bookmark as part of the video desktop recording.

11. The system of claim 10, wherein the metadata further comprises: a title of the target window; a process identifier associated with the target window assigned by an operating system, and a descriptor relating to content within the target window.

12. The system of claim 10, wherein the metadata further comprises a graphical representation of the target window.

13. The system of claim 10, wherein a new bookmark is generated responsive to a new target window being detected.

14. The system of claim 10, wherein the processor is configured to identify the target window from among the at least one window detected within the video desktop recording by performing the steps of:
determining whether at least one window detected within the video desktop recording is in a restored state;
responsive to at least one window being in the restored state, performing the steps of:
determining a top-most window among the at least one window; and
designating the top-most window as the target window.

15. The system of claim 14, wherein the processor is configured to determine the top-most window among the at least one window by performing the steps of:
submitting a query to an operating system, the query requesting enumeration of windows present on the desktop; and
designating a window associated with a first window among the enumerated windows as the target window.

16. A non-transitory computer-readable storage medium storing instructions to be implemented by a computing device having a processor, wherein the instructions, when executed by the processor, cause the computing device to at least:
initiate a video desktop recording capturing activities on a desktop displayed on the computing device, wherein during the video desktop recording, the processor is further configured to:
detect at least one window within the video desktop recording;
identify a target window from among the at least one window detected within the video desktop recording;
responsive to identifying the target window, generate a bookmark comprising metadata associated with the target window, the metadata comprising a time stamp when the target window was identified; and
store the bookmark as part of the video desktop recording.

17. The non-transitory computer-readable storage medium of claim 16, wherein the metadata further comprises: a title of the target window; a process identifier associated with the target window assigned by an operating system executing on the computing device, and a descriptor relating to content within the target window.

18. The non-transitory computer-readable storage medium of claim 16, wherein the metadata further comprises a graphical representation of the target window.

19. The non-transitory computer-readable storage medium of claim 16, wherein a new bookmark is generated responsive to a new target window being detected.

20. The non-transitory computer-readable storage medium of claim 16, wherein the processor is configured to identify the target window from among the at least one window detected within the video desktop recording by performing the steps of:
determining whether at least one window detected within the video desktop recording is in a restored state;
responsive to at least one window being in the restored state, performing the steps of:
determining a top-most window among the at least one window; and
designating the top-most window as the target window.

21. The non-transitory computer-readable storage medium of claim 20, wherein the processor is configured to determine the top-most window among the at least one window by performing the steps of:
submitting a query to an operating system, the query requesting enumeration of windows present on the desktop; and
designating a window associated with a first window among the enumerated windows as the target window.
